(19) United States
(12) Patent Application Publication
(10) Pub. No.: US 2009/0284376 A1
(43) Pub. Date: Nov. 19, 2009

(54) RFID Middleware-Based Sensor Data Stream Processing System and Method

(75) Inventors: Yung Cheol Byun, Cheju-City (KR); Sang Yeol Park, Cheju-City (KR); Young Sik Noh, Cheju-City (KR); Moon Seok Yang, Cheju-City (KR); Ji Woong Byun, Cheju-City (KR)

Correspondence Address: Grossman, Tucker, Perreault & Pfleger, PLLC, 55 South Commercial Street, Manchester, NH, 03101, US

(73) Assignee: JAVA INFORMATION TECHNOLOGY LTD., Cheju-City (KR)

(21) Appl. No.: 12/431,945

(22) Filed: Apr. 29, 2009

(30) Foreign Application Priority Data
Apr. 29, 2008 (KR) 1020080039900

(51) Int. Cl. G08B 13/14

(52) U.S. Cl. 340/572.1

(57) ABSTRACT

Disclosed herein is a Radio Frequency Identification (RFID) middleware-based sensor data stream processing system and method.

The RFID middleware-based sensor data stream processing system of the present invention includes one or more sensors for measuring and collecting surrounding environmental information, sensor nodes for transmitting data collected by the sensors or receiving sensor management commands, a master node for transmitting or receiving data to or from the sensor nodes and for configuring the data received from the one or more sensors into data having a specific protocol structure applied in common to the sensors, and RFID middleware for receiving the sensor data from the master node, converting the sensor data into data of an Electronic Product Code (EPC), and converting the EPC data into data of a Uniform Resource Name (URN) code.

Accordingly, the present invention has the advantage of processing various types of sensor data as well as RFID tags through RFID middleware, and thus ubiquitous computing can be efficiently realized.

### BACKGROUND OF THE INVENTION

1. Field of the Invention

The present invention relates, in general, to a Radio Frequency Identification (RFID) middleware-based sensor data stream processing system and method, and, more particularly, to an RFID middleware-based sensor data stream processing system and method, which automatically convert typical sensor data into an Electronic Product Code (EPC) format used in RFID middleware, thus enabling the RFID middleware to process typical sensor data without the RFID middleware being revised.

2. Description of the Related Art

Since the formulation of ubiquitous computing by Mark Weiser, research into a Ubiquitous Sensor Network (USN) and Radio Frequency Identification (RFID) has been actively conducted as technologies for realizing such ubiquitous computing.

Ubiquitous computing refers to a technology for enabling computers to be naturally and conveniently used in daily life by constructing optimal computing and networking environments among human beings, objects and space in which various computers are permeated into the devices, environments and objects of the real world, and communication services can be used by any device at anytime and anywhere.

USN is a network in which sensors are attached in all the required places and even the surrounding environment information such as temperature, pressure, contamination or cracks, as well as the recognition information of objects, is collected in real time through various types of sensors and is thus managed and controlled.

RFID is a non-contact recognition technology for attaching electronic tags to various types of objects and transmitting and processing object information and surrounding environment information using radio frequencies.

That is, RFID is a technology wherein a reader automatically recognizes the data stored in tags having a micro-chip therein in a non-contact manner using radio frequencies. In this case, RFID tags are attached to all required objects (in all the required places), and even surrounding situation and environment information, as well as the recognition information of objects, may be recognized.

An RFID system includes RFID tags, a reader, and a host supporting the reader.

Such an RFID tag includes memory and an antenna, and functions to transmit information stored in the memory to the RFID reader.

However, RFID and USN are recognized as separate research fields in spite of their technical similarity and mutual influence, so that research into the technical integration of RFID and USN has actually been insufficient.

Recently, research and development into applications and technologies for providing various types of services, such as physical distribution, retailing, medical treatment, automation and security of plants, homes, and offices, disaster prevention, and property management, using RFID technology have been conducted. In order to easily construct ubiquitous application services using RFID technology, middleware playing a bridge role between objects to which RFID tags are attached and application services is required.

RFID middleware enables mutual cooperation between heterogeneous operating systems, and supports the reliability of distributed processing, the independence of networks, and the mutual operability and transparency between application programs and services. Further, middleware functions to manage various types of sensors, collect data using the protocols of the sensors, extract meaningful information or types of information that can be easily used by applications from collected raw information, and transmit the extracted information to application services.

Meanwhile, in Application Level Events (ALE) which are RFID middleware specifications complying with existing international standards, the processing of sensor data streams other than RFID is not considered.

From a typical standpoint, an RFID device is a sensor for recognizing a tag, and thus it is required that RFID middleware is capable of processing various types of sensor data as well as RFID tags and then ubiquitous computing is efficiently realized.

### SUMMARY OF THE INVENTION

Accordingly, the present invention has been made keeping in mind the above problems occurring in the prior art, and an object of the present invention is to provide an RFID middleware-based sensor data stream processing system and method, which automatically convert typical sensor data into an Electronic Product Code (EPC) format used in RFID middleware, thus enabling the RFID middleware to process typical sensor data without the RFID middleware being revised.

In order to accomplish the above object, the present invention provides a Radio Frequency Identification (RFID) middleware-based sensor data stream processing system, comprising one or more sensors for measuring and collecting surrounding environment information, sensor nodes for transmitting data collected by the sensors, or receiving sensor management commands, a master node for configuring data received from the one or more sensors into data having a specific protocol structure applied in common to the sensors while performing transmission or reception to or from the sensor nodes, and RFID middleware for receiving the sensor data having the specific protocol structure from the master node, converting the sensor data into Electronic Product Code (EPC) data, and converting the EPC data into a Uniform Resource Name (URN) code.

The sensor nodes and the master node may be implemented as RF modems.

Further, the RFID middleware-based sensor data stream processing system further comprises a communication module for communicating with the sensor nodes, an error check module for checking for errors in the data, a code conversion module for converting the sensor data into the EPC data, and a URN conversion module for processing the data, converted into the EPC data, into the URN code which is code processed in existing middleware.

Further, the RFID middleware comprises a SensorListener class for communicating with the master node, a SensorData class for storing sensed data, a SensorInfo class for storing information about the respective sensors, a TranslaterFactory class for converting the sensor data into a code compatible with an EPC system, and a URNMakerFactory class for converting the data, converted into the EPC data, into the URN code.

Further, the protocol structure includes a header, a main frame, and a tail, the header includes an STX field indicating start of data, a Length field indicating length of the data, a Router ID field indicating the master node, and a Node ID field indicating a sensor, the main frame includes a command (Cmd) field for managing a sensor and a data field indicating data collected by the sensor, and the tail includes a CheckSum field for checking for errors in the data and an ETX field indicating end of data.

Further, the data converted into the EPC data includes a header part for storing sensor type information and a data part for storing data transmitted by the sensor.

The URN code is configured in a format of ‘urn:sensor: manufacturing company: sensor type: data’.

Meanwhile, the present invention provides a Radio Frequency Identification (RFID) middleware-based sensor data stream processing method, comprising, when data transmitted from a sensor node is transmitted from a master node to RFID middleware in a structure of a specific protocol, the middleware reading the transmitted protocol data, determining a type of sensor using a code assigned to a sensor node ID of the protocol data read by the RFID middleware, determining whether data is sensed data or state information using a command of the protocol data read by the RFID middleware, assigning a header code to the data transmitted to the RFID middleware according to a type of sensor, converting protocol data, to which the header code is assigned according to the sensor type, into Electronic Product Code (EPC) data according to the sensor type, and converting the data, converted into the EPC data, into a Uniform Resource Name (URN) code of the sensor on a basis of the information of the header code.

In addition, the present invention provides a Radio Frequency Identification (RFID) middleware-based sensor data stream processing method, comprising a SensorListener class receiving sensor data having a specific protocol structure while communicating with a master node, determining a sensor type of the received data, and then determining whether the data is sensed information or state information, the SensorListener class assigning the sensor type to an attribute of a data object, assigning sensed information or state information to data, and converting the data into EPC data by performing data conversion, a TranslaterFactory class generating a data conversion object corresponding to the sensor type so as to perform data conversion suitable for each sensor, and a URNMakerFactory class extracting header information from a data object having a format similar to that of an EPC and generating a conversion object corresponding to the header information to generate a data conversion object compatible with the header information, and the conversion object converting the data into a Uniform Resource Name (URN) code.

Further, the specific protocol structure includes a header, a main frame, and a tail, the header includes an STX field indicating start of data, a Length field indicating length of the data, a Router ID field indicating the master node, and a Node ID field indicating a sensor, the main frame includes a command (Cmd) field for managing a sensor and a data field indicating data collected by the sensor, and the tail includes a CheckSum field for checking for errors in the data and an ETX field indicating end of data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic diagram showing the overall construction of an RFID middleware-based sensor data stream processing system according to the present invention;

FIG. 2 is a diagram showing the structure of a protocol for RFID middleware-based sensor data transmission according to the present invention;

FIG. 3 is a diagram showing an RFID middleware-based sensor data conversion process according to the present invention;

FIG. 4 is a diagram showing the configuration of an EPC for RFID middleware-based sensor data according to the present invention;

FIG. 5 is a diagram showing the principal classes for sensor data conversion according to the present invention; and

FIG. 6 is a sequence diagram for sensor data conversion using the classes of FIG. 5.

### DESCRIPTION OF THE PREFERRED EMBODIMENTS

Hereinafter, embodiments of the present invention will be described in detail with reference to the attached drawings.

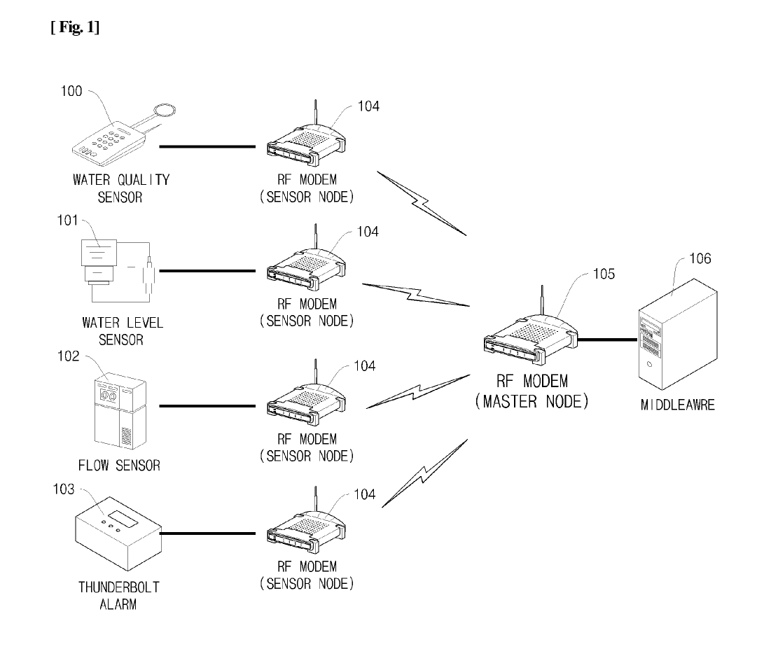

FIG. 1 is a schematic diagram showing the overall construction of an RFID middleware-based sensor data stream processing system according to the present invention.

In FIG. 1, an RFID middleware-based sensor data stream processing system according to the present invention includes sensors 100, 101, 102 and 103 for collecting surrounding environment information, sensor nodes 104 for transmitting data collected by the sensors, or receiving sensor management commands, a master node 105 for configuring the data received from one or more sensors into data having a specific protocol structure applied in common to the one or more sensors while performing transmission or reception to or from the sensor nodes, and RFID middleware 106 for receiving the sensor data from the master node, converting the sensor data into EPC data, and then converting the EPC data into a Uniform Resource Name (URN) code.

Referring to FIG. 1, the system includes the sensors 100 to 103 for collecting surrounding environment information, the RF modems (sensor nodes) 104 for transmitting the data collected by the sensors or receiving sensor management commands, the RF modem (master node) 105 for transmitting or receiving data to or from the sensor nodes, and the middleware 106.

The sensors 100 to 103 transmit data collected from surrounding environments to the master node 105 through the sensor nodes 104, and the master node 105 transmits the sensor data received from the sensor nodes 104 to the middleware 106.

Standardization for the representation of sensor data is not established unlike RFID tag data, and sensor data has various data protocols depending on sensor type, sensor manufacturing company or application.

In order to implement an actual system, in FIG. 1, the master node 105 includes a communication module for communicating with the sensor nodes 104, and the middleware 106 includes an error check module for checking for errors in the data, a code conversion module for converting the sensor data into EPC data, and a URN conversion module for converting the data, converted into the EPC data, into a URN code which is the code processed in existing middleware.

In FIG. 1, a water quality sensor 100, a water level sensor 101, a flow sensor 102, and a thunderbolt sensor 103 are shown as examples of the sensors.

The sensors shown in FIG. 1 have the following hardware specifications described in Table 1.

TABLE 1
(sensor hardware spec)

| | Manufacturing | | |
|---|---|---|---|
| Type | company | Model | Description |
| Water | A company | Hach sc1000 Multi- | Return measured |
| quality | | parameter Universal | electric |
| sensor | | Controller | conductivity, |
| | | | temperature, |
| | | | residual chlorine, |
| | | | Ph, and turbidity |
| Water level | B company | PS7000 | Return measured |
| sensor | | | water level |
| Flow sensor | C company | Win TEC WTM100 | Return measured |
| | | | instantaneous flow |
| | | | rate, accumulated |
| | | | flow rate, |
| | | | instantaneous flow |
| | | | velocity, and total |
| | | | time |
| Thunderbolt | D company | CORONARM-40 | Return thunderbolt |
| alarm sensor | | | alarm value |

Methods of measuring water level may be classified into direct and indirect methods. The former includes a direct observation method and a method using a float, and the latter includes a method using pressure measurement, a method using sound and other methods using various types of physical phenomena. The structure of water level data of the water level sensor used in the embodiment of the present invention is shown in Table 2.

TABLE 2
(water level data structure)

| | Data | | |
|---|---|---|---|
| Item | Water level | Measured value | Checksum |
| Value | OXOA | OX value | OX checksum |
| Size (byte) | 1 | 4 | 1 |

The flow sensor is a flow rate measuring device designed in such a way as to form a magnetic field using Faraday's law on a pipe, through which fluid flows, and to use Fleming's right hand rule indicating that an electromotive force is generated when fluid flows around the magnetic field. Such a flow sensor is also called an electronic flow meter.

Since the electronic flow meter can measure flow rate when conductivity is 5μ/cm or more regardless of temperature, density, pressure, viscosity and the existence of a solid, it has been widely used in fields in which a fluid flow rate must be accurately managed, such as fields of city water, foul water, dirty water, waste water, chemistry, oil refining, iron manufacturing, and paper manufacturing. The data of the electronic flow sensor has the following structure.

TABLE 3
(structure of flow sensor data)

| | Data | | | | | | | | |
|---|---|---|---|---|---|---|---|---|---|
| | Instant | | | | Instant | | | | |
| | flow | Measured | Accumulated | Measured | flow | Measured | Total | Measured | Check |
| Item | rate | value | flow rate | value | velocity | value | time | value | sum |
| Value | 0xOA | 0xvalue1 | 0xOB | 0xvalue2 | 0xOC | 0xvalue3 | 0xOD | 0xvalue4 | 0x |
| | | | | | | | | | Check |
| | | | | | | | | | sum |
| Size | 1 | 4 | 1 | 8 | 1 | 4 | 1 | 7 | 1 |
| (byte) | | | | | | | | | |

The thunderbolt alarm determines whether a thundercloud has approached by measuring the frequency and intensity of electronic shock waves of the thundercloud, measures variation in an electric field attributable to the approaching thundercloud and an electric field attributable to lighting discharge, and measures discharge current, thus exactly sensing the movement and progressive development of the thundercloud.

TABLE 4
(thunderbolt alarm data)

| Step | Alarm content |
|---|---|
| First watch | A thundercloud has been generated within a distance |
| | of 20~30 km, and there is a probability of it |
| | causing a thunderstorm after about 30 minutes |
| Second watch | A thundercloud is approaching within a distance of |
| | 10 km, and there is a probability of it causing |
| | thunderbolts in a nearby region after about 10 |
| | minutes |
| Thunderbolt | There is a high probability of thunderbolts in a |
| warning | nearby region, and urgent refuge is required |

Thunderbolt data is divided into three types, that is, first watch, second watch and thunderbolt warning, as shown in Table 4.

In this case, the transmission of data between the sensors 100 to 103 and the middleware 106 requires a common protocol so as to effectively process data having various types of sensor data protocols.

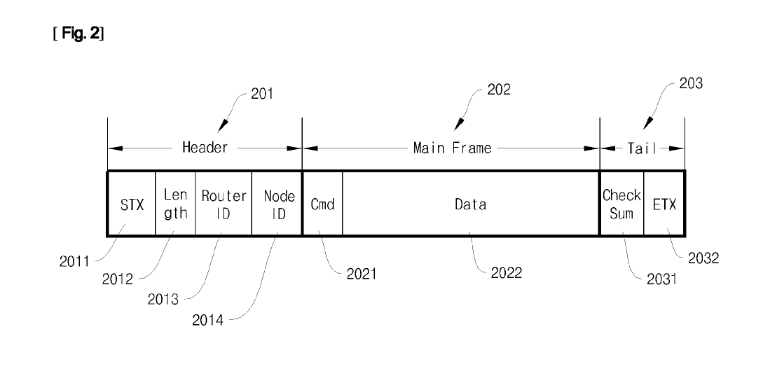

FIG. 2 is a diagram showing the structure of a protocol for RFID middleware-based sensor data transmission according to the present invention.

As shown in FIG. 2, the structure of the protocol includes a header 201, a main frame 202 and a tail 203. The header 201 is composed of an STX field 2011 indicating the start of data, a Length field 2012 indicating the length of data, a Router ID field 2013 indicating a master node, and a Node ID field 2014 indicating a sensor.

The main frame 202 is composed of a command (Cmd) field 2021 for managing a sensor and a data field 2022 for data collected by the sensor. The tail 203 is composed of a CheckSum field 2031 for data error checking and an ETX field 203 indicating the end of data.

The data collected by the sensors is transmitted to the master node 105 through the sensor nodes 104. The master node 105 transmits the data received from the sensor nodes 104 to the middleware 106 in compliance with the structure of a proposed protocol.

In the configuration of the system according to the present invention, each of the sensor nodes 104 designates the sensor node ID 2014 so as to discriminate the types of sensors from each other.

For example, the node ID of the water quality sensor 100 is designated as ‘01’, the node ID of the water level sensor 101 is designated as ‘02’, the node ID of the flow sensor 102 is designated as ‘03’, and the node ID of the thunderbolt alarm 103 is designated as ‘04’. The master node 105 also designates the ID 2013 so as to discriminate the master node 105 to which each sensor node 104 desires to transmit data.

In the case of data obtained by the water level sensor 101, when the ID 2014 of the sensor node 104 is ‘02’ and the ID 2013 of a desired master node 105 is ‘0A’, the header 201 in the structure of data that is transmitted to the middleware 106 is composed of the STX field 2011 ‘02’ indicating the start of a frame, the Length field 2012 indicating the length from the master node ID field 2013 to the checksum field 2031, the router ID field (master node) 2013 ‘0A’, and the sensor node ID field 2014 ‘02’.

The main frame 202 is composed of ‘44’ indicating a command field 2021 commanding the collected data to be transmitted, and the collected data field 2022 ‘10 02 83 84 01 00 01 01 00 00 00 58 6F BD 3F F9 02 15 D0 00 00 00 00 00 00 00 00 00 00 00 00 00 00 BE 8B 10’.

The tail 203 is composed of the checksum field 2031 ‘03 6B’ and the ETX field 2032 ‘03’ indicating the end of the frame.

That is, the structure of the entire water level data transmitted to the middleware 106 is ‘02 29 0A 02 44 10 02 83 84 01 00 01 01 00 00 00 58 6F BD 3F F9 02 15 D0 00 00 00 00 00 00 00 00 00 00 00 00 00 00 BE 8B 10 03 6B 03’.

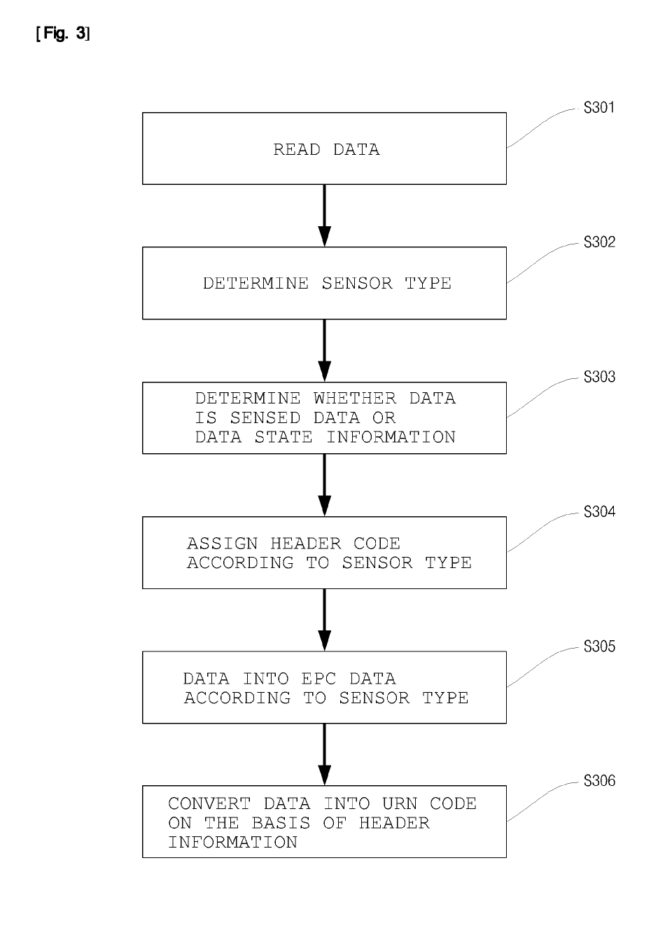

FIG. 3 is a diagram showing an RFID middleware-based sensor data conversion process according to the present invention.

The sensor data conversion process is performed according to the procedure of FIG. 3.

That is, when data from the sensors 100 to 103 and the sensor nodes 104 is transmitted from the master node 105 to the middleware 106 in the form of the above protocol, the middleware 106 reads the transmitted protocol data at step S301.

In this case, the type of sensor is determined using the code assigned to the node ID field 2014 of the protocol data read by the middleware 106 at step S302.

Further, whether the data is sensed data or state information is determined using the command (Cmd) field 2021 of the protocol data read by the middleware 106 at step S303.

That is, for the data transmitted to the middleware, the type of sensor is determined, and whether the data is the state information of the sensor or information collected by the sensor is determined.

Next, a header code is assigned to the data transmitted to the middleware 106 according to the type of sensor at step S304.

The protocol data, to which the header code is assigned according to the sensor type, is converted into EPC data according to the sensor type at step S305.

Finally, the data, converted into the EPC data, is converted into the URN code of the sensor on the basis of the header information at step S306.

Consequently, the sensor data transmitted to the middleware 106 is converted into a format of a code system similar to that of EPC tag data processed by existing middleware.

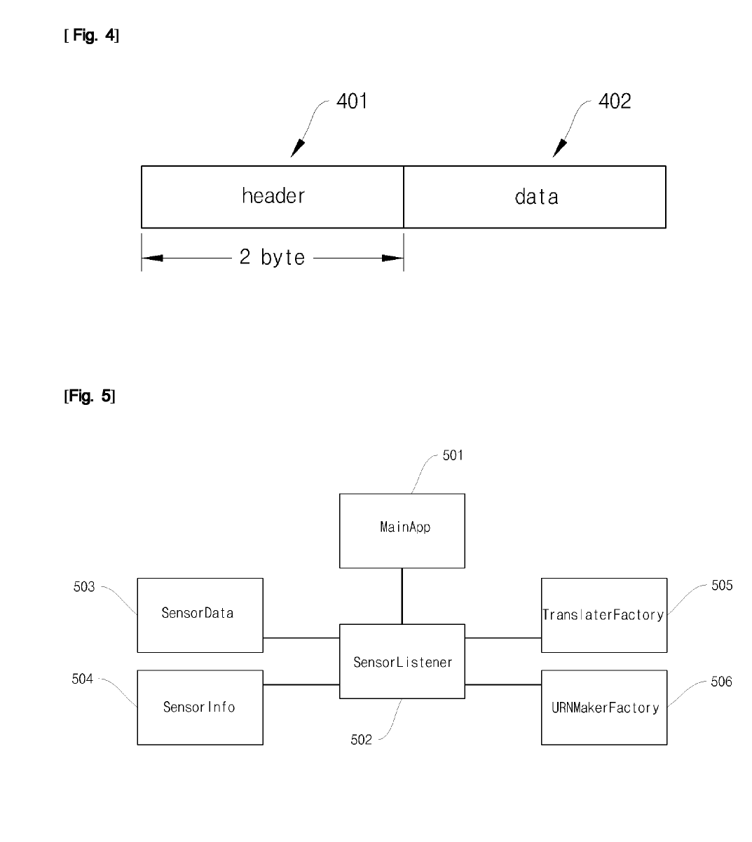

FIG. 4 is a diagram showing the structure of an EPC for RFID middleware-based sensor data according to the present invention.

Sensor data is composed of a header 401 indicating sensor type information and data 402 indicating data actually transmitted by the sensor depending on code systems for respective sensors, as shown in FIG. 4, through the process of FIG. 3.

Table 5 shows headers 401 for respective sensors arbitrarily defined in the present invention.

TABLE 5
(header information for respective sensors)

| Sensor type | header information |
|---|---|
| Water quality sensor | 36000001 |
| Water level sensor | 36000002 |
| Flow sensor | 36000003 |
| Thunderbolt sensor | 36000004 |

In the case of EPC data, tag information is represented by a header indicating the type of code, the manufacturing company of a product, the item code of the product, and the serial number of the product. Similarly to the EPC code, the sensor data of the present invention is also represented by the header 401 indicating the type of sensor and information 402 collected by the sensor.

However, in the EPC, the header indicates a designated code according to a code definition required to represent various types of identification information, but, in the sensor data, the information of the header 401 indicates the type of sensor and the data 402 indicates information collected by the sensor, instead of the product recognition information of the EPC, unlike the EPC system.

Further, in the code of FIG. 4, a sensor is represented with sensed information divided into one or more fields so as to represent the sensed information in the same way that, in the EPC data, information is represented with the information divided into fields such as fields for the manufacturing company, item code and serial number of a product.

For example, since a water level sensor collects only water level information, it has one field. But, a flow sensor has four fields, that is, an instantaneous flow rate, an accumulated flow rate, an instantaneous flow velocity, and total time, in order to represent flow rate information.

Compared to the EPC indicating identification information, sensor information is implemented using various methods to represent respective pieces of collected information.

Therefore, in the data conversion process, a procedure for extracting only actually collected information from a sensor data protocol designated by each sensor manufacturing company is required.

For example, in the case of water level data transmitted from the master node 105, if it is assumed that the header code 410 of water level data is ‘36 00 00 02’, and collected data 402 is ‘44 10 02 83 84 01 00 01 01 00 00 00 58 6F BD 3F F9 02 15 D0 00 00 00 00 00 00 00 00 00 00 00 00 00 00 BE 8B 10’, only an actual water level value is extracted. When the extracted water level value is ‘58 6F BD 3F F9 02 15 D0’, EPC data obtained through conversion is ‘36 00 00 02 58 6F BD 3F F9 02 15 D0’.

That is, during the process for converting the sensor data into EPC data, actually required data is extracted and is converted to allow the meaning of the extracted data to be easily comprehensible.

In this way, similarly to a manner in which the EPC indicates the identification information of a product, the sensor data indicates the type of sensor and collected information in a code through a code conversion process.

The data converted into the EPC data is converted into a URN code that can be processed in the middleware 106.

A sensor data URN code system proposed in the present invention represents the information of the sensor such that the sensor information can be comprehended from the URN code of the sensor in the same way that product identification information can be comprehended from a URN code in the URN format of an EPC.

The sensor data is also represented by a hexadecimal number making the type of sensor and data easy to comprehend in the same way that, in the case of EPC data, data represented by a hexadecimal number according to a method defined in the EPC system is converted into a URN code such as the code information and the manufacturing company information, item code information and serial number information of a product, and is then easily comprehensible by the URN code.

TABLE 6
(proposed URN code system)

| Sensor type | urn system |
|---|---|
| Water level | Urn: sensor: com: water level: water level |
| sensor | |
| Flow sensor | urn: sensor: com: water flux: instantaneous flow |
| | rate. accumulated flow rate. instantaneous flow velocity. |
| | Total time |
| Thunderbolt | urn: senosor: com: thunderbolt: thunderbolt alarm |
| sensor | |

In the present invention, as shown in Table 6, in order to represent the manufacturing company of each sensor, the type of sensor, and the actual data of the sensor, a URN code having a format of ‘urn:sensor: manufacturing company: sensor type: data’ is defined.

When a value collected by the sensor is one water level value as in the case of water level data, a URN code is defined by ‘urn:sensor:com: water level: water level value’. When values collected by the sensor are composed of several values, for example, instantaneous flow rate, accumulated flow rate, instantaneous flow velocity, and total time, as in the case of flow rate data, a URN code is defined by ‘urn:sensor:com:water flux: instantaneous flow rate.accumulated flow rate.instantaneous flow velocity.total time’ with the fields of the URN code separated from each other using a ‘.’.

In this case, when the water level data converted into the EPC data is ‘36 00 00 02 58 6F BD 3F F9 02 15 D0’, ‘36 00 00 02’ indicates a water level sensor according to the information of the header 401, so that the format of a resulting URN code is ‘urn:sensor:a:waterlevel:586FBD3FF90215D0’.

In order to implement the actual system, the RFID middleware-based sensor data stream processing system according to the present invention includes a communication module for communicating with respective sensors, an error check module for checking for errors in the data, a code conversion module for converting the sensor data into EPC data, and a URN conversion module for converting the data, converted into the EPC data, into a URN code which is a code processed in existing middleware. In this case, the principal classes of RFID middleware are shown in FIG. 5.

FIG. 5 is a diagram showing principal classes for sensor data conversion according to the present invention.

As shown in FIG. 5, the RFID middleware 106 includes a SensorListener class 502 functioning to communicate with the master node 105, a SensorData class 503 for storing sensed data, a SensorInfo class 504 for storing information about respective sensors, a TranslaterFactory class 505 for converting the sensor data into a code compatible with an EPC system, and a URNMakerFactory class 506 for converting the data converted into the EPC data into a URN code.

In FIG. 5, a part that is not described is a MainApp class 501 for processing sensed data and applying the processed sensed data.

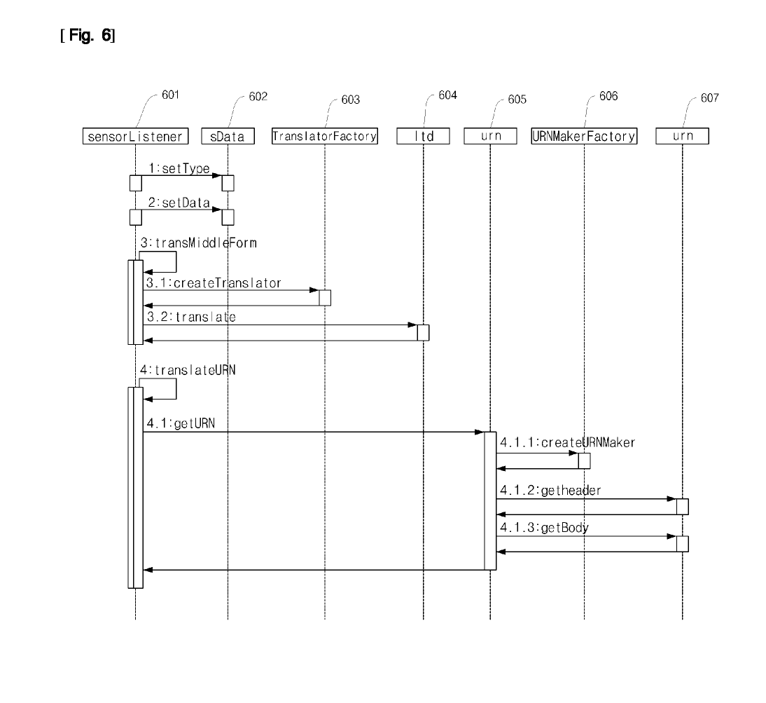

FIG. 6 is a sequence diagram showing the conversion of sensor data using the classes of FIG. 5.

A data conversion process is mainly divided into a data transmission process for receiving data from the master node, and a data conversion process for converting the received data into data that is processed in the middleware.

Further, the data conversion process is divided into a procedure for converting the sensor data into a code similar to the EPC of FIG. 4, and a procedure for converting the data converted as shown in FIG. 4 into a URN code.

Referring to FIG. 6, a SensorListener 601 receives the data of FIG. 2 while communicating with the master node.

Further, the sensor type of the received data is detected, and whether the data is sensed information or state information is determined.

That is, which sensor has sent the data is determined, and whether the sent data is sensed information or state information is determined, and thereafter ‘sensor type’ is assigned as type and sensed information or state information is assigned as data to the attributes of a data object 602.

When data has been assigned, the SensorListener performs data conversion.

First, for the data conversion of FIG. 4, data conversion processes are different from each other for respective sensors, so that a TranslaterFactory object 603 generates data conversion objects 604 corresponding to respective sensor types to perform conversion into data suitable for the respective sensors.

Thereafter, the data conversion objects perform conversion into the data of FIG. 4. After the data conversion process of FIG. 4 has been terminated, the data is converted into a URN code using a method similar to a method of processing EPC data in existing middleware.

That is, similarly to the above-described conversion process, a data object 605 having a format similar to that of an EPC extracts header information 401, and allows a URNMakerFactory 606 to generate a conversion object 607 corresponding to header information so as to generate a data conversion object compatible with the header information. The conversion object 607 converts the data into a URN code.

As described above, the present invention provides a method of efficiently processing various types of sensor data streams other than RFID data on the basis of RFID middleware complying with international standards without revising existing methods.

Therefore, the present invention is advantageous in that middleware, capable of processing sensor data other than RFID data in addition to processing the recognition information of objects using RFID tag information, can be developed, so that various application services can be provided at low costs by utilizing both the object recognition information and the sensor data. That is, middleware provides standardized interfaces for applications and various sensors, thus realizing universality enabling heterogeneous sensors to be easily connected at low cost.

Further, the present invention is advantageous in that it not only can ensure base technology for providing application services based on the integration of RFID/USN, but also can extend methods based on existing international standards, thus obtaining the maximum effect at relatively low cost.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Radio Frequency Identification (RFID) middleware-based sensor data stream processing system, comprising:
one or more sensors for measuring and collecting surrounding environment information;
sensor nodes for transmitting data collected by the sensors, or receiving sensor management commands;
a master node for configuring data received from the one or more sensors into data having a specific protocol structure applied in common to the sensors while performing transmission or reception to or from the sensor nodes; and
RFID middleware for receiving the sensor data having the specific protocol structure from the master node, converting the sensor data into Electronic Product Code (EPC) data, and converting the EPC data into a Uniform Resource Name (URN) code.

2. The RFID middleware-based sensor data stream processing system according to claim 1, wherein the sensor nodes and the master node are implemented as RF modems.

3. The RFID middleware-based sensor data stream processing system according to claim 1, further comprising:
a communication module for communicating with the sensor nodes, an error check module for checking for errors in the data, a code conversion module for converting the sensor data into the EPC data, and a URN conversion module for processing the data, converted into the EPC data, into the URN code which is code processed in existing middleware.

4. The RFID middleware-based sensor data stream processing system according to claim 1, wherein the RFID middleware comprises a SensorListener class for communicating with the master node, a SensorData class for storing sensed data, a SensorInfo class for storing information about the respective sensors, a TranslaterFactory class for converting the sensor data into a code compatible with an EPC system, and a URNMakerFactory class for converting the data, converted into the EPC data, into the URN code.

5. The RFID middleware-based sensor data stream processing system according to claim 1, wherein:
the protocol structure includes a header, a main frame, and a tail,
the header includes an STX field indicating start of data, a Length field indicating length of the data, a Router ID field indicating the master node, and a Node ID field indicating a sensor,
the main frame includes a command (Cmd) field for managing a sensor and a data field indicating data collected by the sensor, and
the tail includes a CheckSum field for checking for errors in the data and an ETX field indicating end of data.

6. The RFID middleware-based sensor data stream processing system according to claim 1, wherein the data converted into the EPC data includes a header part for storing sensor type information and a data part for storing data transmitted by the sensor.

7. The RFID middleware-based sensor data stream processing system according to claim 1, wherein the URN code is configured in a format of ‘urn:sensor: manufacturing company: sensor type: data’.

8. A Radio Frequency Identification (RFID) middleware-based sensor data stream processing method, comprising:
when data transmitted from a sensor node is transmitted from a master node to RFID middleware in a structure of a specific protocol, the middleware reading the transmitted protocol data;
determining a type of sensor using a code assigned to a sensor node ID of the protocol data read by the RFID middleware;
determining whether data is sensed data or state information using a command of the protocol data read by the RFID middleware;
assigning a header code to the data transmitted to the RFID middleware according to a type of sensor;
converting protocol data, to which the header code is assigned according to the sensor type, into Electronic Product Code (EPC) data according to the sensor type; and
converting the data, converted into the EPC data, into a Uniform Resource Name (URN) code of the sensor on a basis of the information of the header code.

9. A Radio Frequency Identification (RFID) middleware-based sensor data stream processing method, comprising:
a SensorListener class receiving sensor data having a specific protocol structure while communicating with a master node, determining a sensor type of the received data, and then determining whether the data is sensed information or state information;
the SensorListener class assigning the sensor type to an attribute of a data object, assigning sensed information or state information to data, and converting the data into EPC data by performing data conversion;
a TranslaterFactory class generating a data conversion object corresponding to the sensor type so as to perform data conversion suitable for each sensor; and
a URNMakerFactory class extracting header information from a data object having a format similar to that of an EPC and generating a conversion object corresponding to the header information to generate a data conversion object compatible with the header information, and the conversion object converting the data into a Uniform Resource Name (URN) code.

10. The RFID middleware-based sensor data stream processing method according to claim 8, wherein:
the specific protocol structure includes a header, a main frame, and a tail,
the header includes an STX field indicating start of data, a Length field indicating length of the data, a Router ID field indicating the master node, and a Node ID field indicating a sensor,
the main frame includes a command (Cmd) field for managing a sensor and a data field indicating data collected by the sensor, and
the tail includes a CheckSum field for checking for errors in the data and an ETX field indicating end of data.

11. The RFID middleware-based sensor data stream processing method according to claim 9, wherein:
the specific protocol structure includes a header, a main frame, and a tail,
the header includes an STX field indicating start of data, a Length field indicating length of the data, a Router ID field indicating the master node, and a Node ID field indicating a sensor,
the main frame includes a command (Cmd) field for managing a sensor and a data field indicating data collected by the sensor, and
the tail includes a CheckSum field for checking for errors in the data and an ETX field indicating end of data.
